(19) United States
(12) Patent Application Publication
(10) Pub. No.: US 2025/0103388 A1
(43) Pub. Date: Mar. 27, 2025

(54) CENTRAL PROCESSING UNIT, I3C CONTROLLER, AND PROCESSING METHOD FOR TASK PACKET

(71) Applicant: REALTEK SEMICONDUCTOR CORP., Hsinchu (TW)

(72) Inventors: Yue-Feng Chen, Suzhou (CN); Feng Xiong, Suzhou (CN); Bo-Ai Li, Suzhou (CN)

(73) Assignee: REALTEK SEMICONDUCTOR CORP., Hsinchu (TW)

(21) Appl. No.: 18/891,859

(22) Filed: Sep. 20, 2024

(30) Foreign Application Priority Data
Sep. 27, 2023 (CN) 202311262295.5

(51) Int. Cl. G06F 9/48

(52) U.S. Cl. CPC G06F 9/4881; G06F 9/485

(57) ABSTRACT

A central processing unit includes a processing module and an output module. The processing module is configured to generate a task packet according to an execution task. The output module is configured to output the task packet to an I3C controller, such that the I3C controller executes the task packet to complete the execution task. The task packet includes a definition word and at least one data byte sequentially concatenated to the definition word. The definition word includes four setting bytes that are sequentially concatenated one another and respectively define a first write number for a first write operation, a second write number for a second write operation, a read number for a read operation, and a third write number for a third write operation. The execution task includes at least one of the first write operation, the second write operation, the read operation, and the third write operation.

### CROSS-REFERENCE TO RELATED APPLICATION

This non-provisional application claims priority under 35 U.S.C. § 119 (a) to patent application No. 202311262295.5 filed in China on Sep. 27, 2023, the entire contents of which are hereby incorporated by reference.

### BACKGROUND

### Technical Field

The instant disclosure relates to the technology of I3C (improved inter integrated circuit). In particular, according to one or some embodiments, the instant disclosure relates to a central processing unit, I3C controller, and processing method for a task packet that can simplify a processing flow of the I3C controller and reduce the load of the central processing unit.

### Related Art

Generally, in response to designing an I3C (improved inter integrated circuit) controller, multiple combined operations can be achieved by issuing commands multiple times, or complex logic can be directly implemented in the I3C controller. Take an ENTDAA (enter dynamic address assignment) in a common command for example, a central processing unit known to the inventor usually splits the task of the ENTDAA into multiple commands and then sends the multiple commands to the I3C controller.

### SUMMARY

In an embodiment, a central processing unit includes a processing module and an output module. The output module is configured to generate a task packet according to an execution task. The output module is configured to output the task packet to an I3C (improved inter integrated circuit) controller coupled to the central processing unit, such that the I3C controller executes the task packet to complete the execution task. The task packet includes a definition word and at least one data byte. The at least one data byte sequentially follows the definition word. The definition word includes a first setting byte, a second setting byte, a third setting byte, and a fourth setting byte that are sequentially concatenated one another. The first setting byte defines a first write number for a first write operation. The second setting byte defines a second write number for a second write operation. The third setting byte defines a read number for a read operation. The fourth setting byte defines a third write number for a third write operation. The execution task includes at least one selected from the group consisting of the first write operation, the second write operation, the read operation, and the third write operation.

In an embodiment, an I3C controller includes a receive module and an execution module. The receive module is configured to receive a task packet. The execution module is configured to execute the task packet to complete an execution task. The task packet includes a definition word and at least one data byte. The at least one data byte sequentially follows the definition word. The definition word includes a first setting byte, a second setting byte, a third setting byte, and a fourth setting byte that are sequentially concatenated one another. The first setting byte defines a first write number for a first write operation. The second setting byte defines a second write number for a second write operation. The third setting byte defines a read number for a read operation. The fourth setting byte defines a third write number for a third write operation. The execution task includes at least one selected from the group consisting of the first write operation, the second write operation, the read operation, and the third write operation.

In an embodiment, a processing method for a task packet includes: generating, using a central processing unit, a definition word according to an execution task, wherein the definition word includes a first setting byte, a second setting byte, a third setting byte, and a fourth setting byte that are sequentially concatenated one another, the first setting byte defines a first write number for a first write operation, the second setting byte defines a second write number for a second write operation, the third setting byte defines a read number for a read operation, the fourth setting byte defines a third write number for a third write operation, and the execution task includes at least one selected from the group consisting of the first write operation, the second write operation, the read operation, and the third write operation; generating, using the central processing unit, at least one data byte according to the execution task; concatenating, using the central processing unit, the at least one data byte after the definition word to generate a task packet; and outputting, using the central processing unit, the task packet to an I3C controller, such that the I3C controller executes the task packet to complete the execution task.

In some embodiment, the processing method for a task packet further includes: receiving using the I3C controller, the task packet; and executing, using the I3C controller, the task packet to complete the execution task, wherein the I3C controller sequentially: performs the first write operation with the first write number of first data byte in the at least one data byte according to the first setting byte, performs the second write operation with the second write number of second data byte in the at least one data byte according to the second setting byte, performs the read operation according to the read number of the third setting byte, and performs the third write operation with the third write number of third data byte in the at least one data byte according to the fourth setting byte.

To sum up, according to the central processing unit, the I3C controller, and the processing method for the task packet of one or some embodiments of the instant disclosure, according to an execution task, a task packet can be generated or the task packet of the execution task can be executed, so that the central processing unit sends the instructions and data for the I3C controller to complete the execution task to the I3C controller in a single task packet at once, such that the execution of the execution task is completed after the I3C controller completes the execution of the task packet. As a result, during the process of the I3C controller executing the task packet (i.e., before the completion of the execution task), the central processing unit does not need to access the I3C controller again, thereby greatly simplifying the processing flow of the I3C controller, and thus the waiting time and access times of the central processing unit to the I3C controller can be reduced (i.e., an intervention of the central processing unit can be reduced) to reduce the loading of the central processing unit.

Detailed features and advantages of the instant disclosure are described in detail in the following implementations, and the content of the implementations is sufficient for a person skilled in the art to understand and implement the technical content of the instant disclosure. A person skilled in the art can easily understand the objectives and advantages related to the instant disclosure according to the contents disclosed in this specification, the claims and the drawings.

### BRIEF DESCRIPTION OF THE DRAWINGS

The instant disclosure will become more fully understood from the detailed description given herein below for illustration only and therefore not limitative of the instant disclosure, wherein:

FIG. 1 illustrates a schematic block diagram of a system according to an embodiment of the instant disclosure;

FIG. 2 illustrates a schematic view of a task packet according to an embodiment of the instant disclosure;

FIG. 3 illustrates a schematic flowchart of a generation method for a task packet according to an embodiment of the instant disclosure;

FIG. 4 illustrates a schematic view of a task packet according to an embodiment of the instant disclosure;

FIG. 5 illustrates a schematic flowchart of an execution method for a task packet according to an embodiment of the instant disclosure;

FIG. 6 illustrates a schematic view of a task packet according to an embodiment of the instant disclosure;

FIG. 7 illustrates a schematic view of a task packet according to an embodiment of the instant disclosure;

FIG. 8 illustrates a schematic view of a task packet according to an embodiment of the instant disclosure; and

FIG. 9 illustrates a schematic view of a task packet according to an embodiment of the instant disclosure.

### DETAILED DESCRIPTION

To make the objectives, features, and advantages of the embodiments of the instant disclosure more comprehensible, the following provides detailed descriptions with reference to the accompanying drawings.

It should be understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

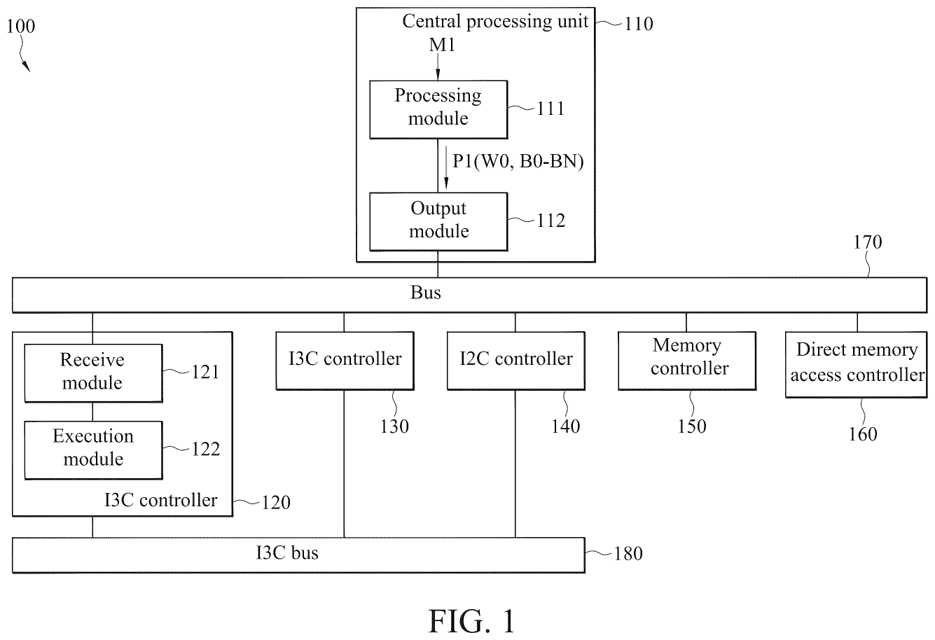

FIG. 1 illustrates a schematic block diagram of a system 100 according to an embodiment of the instant disclosure. Please refer to FIG. 1. The system 100 includes a central processing unit 110 and an I3C (improved inter integrated circuit) controller 120, and the central processing unit 110 is coupled to the I3C controller 120.

In some embodiments, the system 100 may further include at least one I3C controller 130, an I2C (inter integrated circuit) controller 140, a memory controller 150, a direct memory access controller (DMAC) 160, or other electronic elements. In these embodiments, the I3C controller 120 is a master controller, and the I3C controller 130 is a slave controller.

In some embodiments, the central processing unit 110, the I3C controller 120, the I3C controller 130, the I2C controller 140, the memory access controller 150, and the direct memory access controller 160 may be connected to each other through a bus 170 for mutual communication. Furthermore, the I3C controller 120, the I3C controller 130, and the I2C controller 140 may further be connected to each other through an I3C bus 180.

In some implementations, the bus 170 may adopt an advanced microcontroller bus architecture (AMBA) protocol. The bus 170 may be, but not limited to, an advanced peripheral bus (APB), an advanced extensible interface (AXI), or an advanced high-performance bus (AHB). The I3C bus 180 includes a serial data (SDA) line and a serial clock (SCL) line. Furthermore, each of the central processing unit 110, the I3C controller 120, the I3C controller 130, the I2C controller 140, the memory controller 150, and the direct memory access controller 160 may be, for example, but not limited to, an embedded controller (EC), a system on chip (SoC), a central processing unit (CPU), a microcontroller (MCU), an application special integrated circuit (ASIC), an application processor (AP), a digital signal processor (DSP), a programmable logic device (PLD), or any other suitable electronic components.

In some embodiments, the central processing unit 110 includes a processing module 111 and an output module 112. The processing module 111 is coupled to the output module 112, and the output module 112 is coupled to the I3C controller 120. The processing module 111 is configured to generate a task packet P1 according to an execution task M1 and to transmit the task packet P1 to the output module 112. The output module 112 is configured to output the task packet P1 to the I3C controller 120. For example, the output module 112 transmits the task packet P1 to the I3C controller 120 through the bus 170.

In some embodiments, the execution task M1 may be written in a programming language. In some embodiments, the programming language may be, for example, but not limited to, C, C++, Verilog, machine language, or any other suitable programming languages. In some embodiments, the I3C controller 120 includes a receive module 121 and

an execution module 122. The execution module 122 is coupled to the receive module 121, and the receive module 121 may be coupled to the output module 112 of the central processing unit 110 through, for example, but not limited to, the bus 170. The receive module 121 is configured to receive the task packet P1 from the central processing unit 110 and to transmit the task packet P1 to the execution module 122. The execution module 122 is configured to execute the task packet P1 to complete the execution task M1. In these embodiments, the task packet P1 includes all the instructions and data for the I3C controller 120 to complete the execution task M1.

It is worth noting that, to clearly illustrate the instant disclosure, FIG. 1 of the instant disclosure is a simplified block diagram showing only elements relevant to one or some embodiments of the instant disclosure. A person skilled in the art should understand that either the system 100, the central processing unit 110, or the I3C controller 120 may include other elements for providing specific functions.

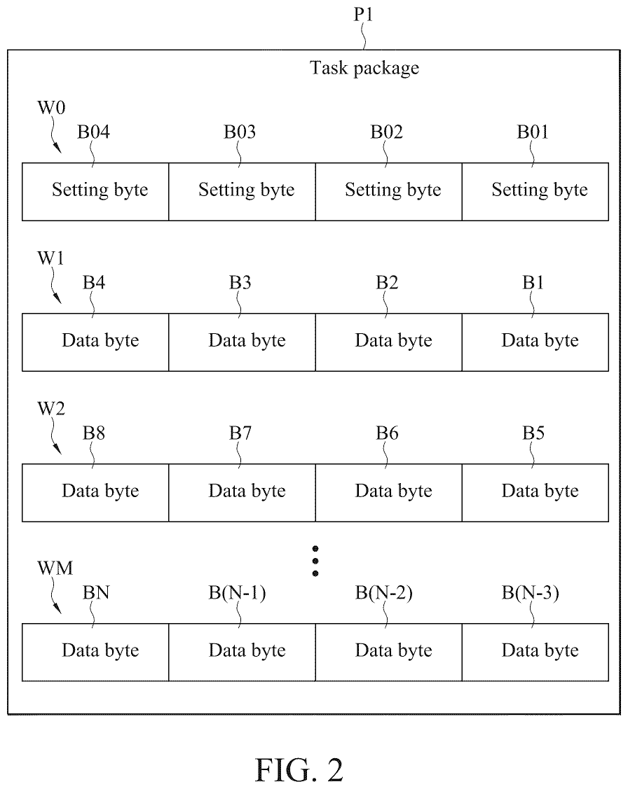

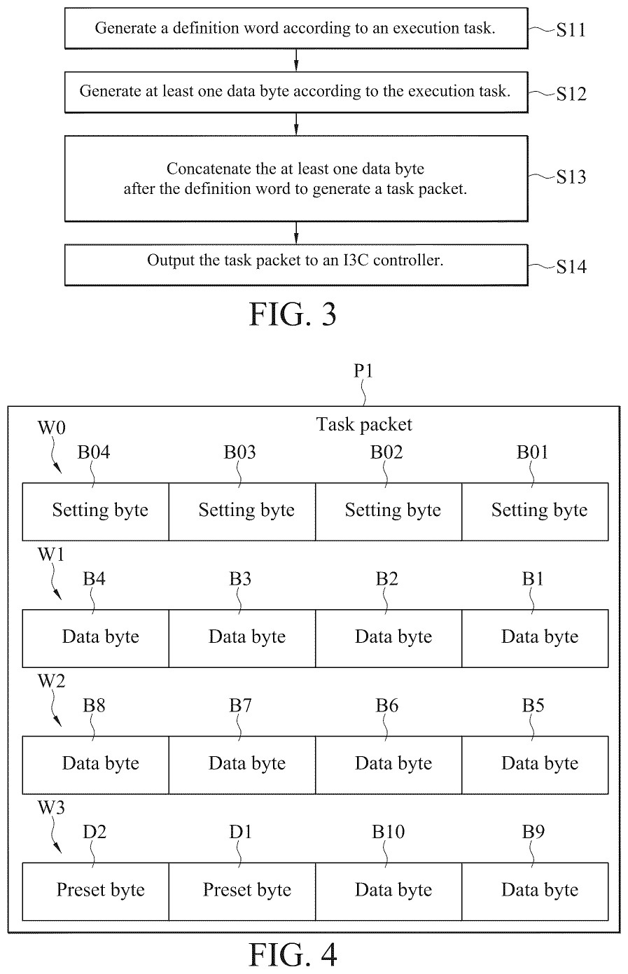

The system 100 can implement a processing method for a task packet P1 according to any embodiments, such as to generate and execute the task packet P1. In some embodiments, the processing method includes a generation method and an execution method. FIG. 2 illustrates a schematic view of a task packet P1 according to an embodiment of the instant disclosure. FIG. 3 illustrates a schematic flowchart of a generation method for a task packet P1 according to an embodiment of the instant disclosure. Please refer to FIG. 1 to FIG. 3. The central processing unit 110 can generate and output the task packet P1 of the execution task M1 to the I3C controller 120 by executing the generation method for the task packet P1 according to any embodiments of the instant disclosure.

Specifically, according to one or some embodiments of the instant disclosure, the processing module 111 of the central processing unit 110 performs the following steps: generating a definition word W0 corresponding to a content of an execution task M1 according to the content of the execution task M1 (step S11); generating at least one byte (hereinafter, referred to as at least one data byte B1-BN) corresponding to the content of the execution task M1 according to the content of the execution task M1 (step S12); concatenating the at least one data byte B1-BN after the definition word W0 to generate a task packet P1 (step S13). In some embodiments, N is a positive integer greater than or equal to 1.

In some embodiments, in the step S11, the processing module 111 of the central processing unit 110 generates a definition word W0 corresponding to an operation setting of the execution task M1. In these embodiments, in the step S12, the processing module 111 of the central processing unit 110 generates at least one data byte B1-BN corresponding to an operation content (i.e., the instructions and data) of the execution task M1.

In some embodiments, the central processing unit 110 can generate the at least one data byte B1-BN in the form of words. In other words, in some embodiments, in the step S12, the central processing unit 110 generates at least one data word W1-WM consisting of the at least one data byte B1-BN. In these embodiments, M is a positive integer greater than or equal to 1.

In some embodiments, the definition word W0 includes multiple bytes (hereinafter, referred to as setting bytes, respectively) that are sequentially concatenated one another, and each of the at least one data word W1-WM and the definition word W0 may have the same number of bytes. In other words, in some embodiments, the at least one data byte B1-BN is sequentially combined as the at least one data word W1-WM, wherein each of the at least one data word W1-WM and the definition word W0 have the same number of bytes. In some embodiments, in response to that the number of the at least one data byte B1-BN is not a multiple of the number of bytes of the definition word W0, the last data byte WM is consisting of at least one data byte and one or more preset bytes. In these embodiments, each of the preset bytes may have identical or different preset values.

In some embodiments, each of the setting bytes of the definition word W0 represents a specified operation (for example, a write operation or a read operation) and indicates the total number of the bytes of instructions and data for the specified operation that the setting byte represents.

In some embodiments, the definition word W0 and the at least one data word W1-WM are sequentially concatenated one another, and each word (i.e., one of the words W0-WM) is consisting of four bytes. For example, the definition word W0 may be consisting of four setting bytes B01-B04, the data word W1 may be consisting of four data bytes B1-B4, the data word W2 may be consisting of four data bytes B5-B8, and so on. In some embodiments, each of the at least one data byte B1-BN is consisting of 8 bits.

In some embodiments, the definition word W0 may be consisting of four setting bytes B01-B04 that are sequentially concatenated one another (hereinafter, referred to as a first setting byte B01, a second setting byte B02, a third setting byte B03, and a fourth setting byte B04, respectively). In these embodiments, the first setting byte B01, the second setting byte B02, the third setting byte B03, and the fourth setting byte may be arranged in sequence from the lower bit to the higher bit. In some implementations, each of the setting bytes B01-B04 of the definition word W0 is consisting of 8 bits.

In some embodiments, the first setting byte B01 defines a first write number for a first write operation. The second setting byte B02 defines a second write number for a second write operation. The third setting byte B03 defines a read number for a read operation. The fourth setting byte B04 defines a third write number for a third write operation. Specifically, in some embodiments, the value represented by the first setting byte B01 (i.e., the first write number) indicates the number of data bytes for the execution of the first write operation in the at least one data byte B1-BN. The value represented by the second setting byte B02 (i.e., the second write number) indicates the number of data bytes for the execution of the second write operation in the at least one data byte B1-BN. The value represented by the third setting byte B03 (i.e., the read number) indicates the number of data to be read in the read operation. The value represented by the fourth setting byte B04 (i.e., the third write number) indicates the number of data bytes for the execution of the third write operation in the at least one data byte B1-BN.

In some embodiments, at least one among the first write number, the second write number, the read number, and the third write number has a value other than 0. In other words, in some embodiments, the execution task M1 includes at least one selected from the group consisting of the first write operation, the second write operation, the read operation, and the third write operation, such that in response to that the I3C controller 120 executes the task packet P1, the I3C controller 120 executes at least one selected from the group consisting of the first write operation, the second write operation, the read operation, and the third write operation.

In some embodiments, in the at least one data byte B1-BN, the data byte for performing the first write operation (hereinafter, each data byte is referred to as a first data byte), the data byte for performing the second write operation (hereinafter, each data byte is referred to as a second data byte), and the data byte for performing the third write operation (hereinafter, each data byte is referred to as a third data byte) do not overlap and can be arranged in sequence.

In other words, in some embodiments, each of the at least one data byte B1-BN is only for a corresponding one of the first write operation, the second write operation, and the third write operation, and the at least one data byte B1-BN may be consisting of the first data byte, the second data byte, and the third data byte that are sequentially concatenated one another.

Take the task packet P1 including four data bytes B1-B4 as an example, the data bytes B1-B2 may be the first data bytes, respectively, the data byte B3 may be the second data byte, and the data byte B4 may be the third data byte.

In some embodiments, firstly, the central processing unit 110 can generate the definition word W0 and the at least one data byte B1-BN one by one and temporarily store the definition word W0 and the at least one data byte B1-BN. After the definition word W0 and the at least one data byte B1-BN are generated, the central processing unit 110 sequentially concatenates the at least one data byte B1-BN after the definition word W0 to form the task packet P1, but the instant disclosure is not limited thereto. In some other embodiments, the central processing unit 110 can sequentially generate and concatenate the definition word W0 and the at least one data byte B1-BN into the task packet P1 directly.

FIG. 4 illustrates a schematic view of a task packet P1 according to an embodiment of the instant disclosure. Please refer to FIG. 1 and FIG. 4. In some embodiments, in response to that the total number of the at least one data byte B1-BN is not a multiple of four, the central processing unit 110 additionally generates, according to the insufficient number, at least one preset byte having a preset value, such that the total number of the at least one data byte B1-BN and the at least one preset byte can be a multiple of four and thus the central processing unit 110 can generate the at least one data word W1-WM.

Take a task packet P1 including ten data bytes B1-B10 for an example, the central processing unit 110 additionally generates two preset bytes D1-D2, so that the central processing unit 110 generates data words W1-W3 according to the data bytes B1-B10 and the preset bytes D1-D2. In this example, the data word W1 is consisting of the data bytes B1-B4, the data word W2 is consisting of the data bytes B5-B8, and the data word W3 is consisting of the data bytes B9-B10 and the preset bytes D1-D2. In some embodiments, the preset values of the preset bytes D1-D2 may respectively be, but not limited to 0 (i.e., the preset bytes D1-D2 may be 8′b0, respectively). However, the instant disclosure is not limited thereto. In other some embodiments, the preset values of the preset bytes D1-D2 may be different from each other.

Please refer to FIG. 1 and FIG. 3 again. In an embodiment of the generation method for a task packet P1, after the processing module 111 of the central processing unit 110 generates the task packet P1 in the step S13, the processing module 111 transmits the task packet P1 to the output module 112. Then, the output module 112 transmits the task packet P1 to the I3C controller 120 through the bus 170, so that the I3C controller 120 can execute the task packet P1 to complete the execution task M1 corresponding to the task packet P1 (step S14).

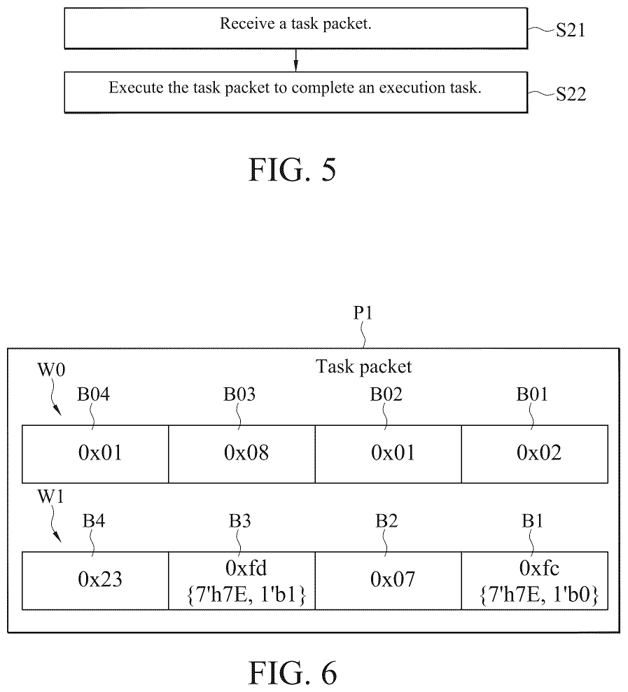

FIG. 5 illustrates a schematic flowchart of an execution method for a task packet P1 according to an embodiment of the instant disclosure. Please refer to FIG. 1, FIG. 2, and FIG. 5. The I3C controller 120 can perform the execution method for the task packet P1 according to any embodiments of the instant disclosure. In an embodiment of the execution method for the task packet P1, the I3C controller 120 receives the task packet Plfrom the central processing unit 110 by using the receive module 121 through the bus 170 (step S21). After the receive module 121 receives the task packet P1, the receive module 121 transmits the task packet P1 to the execution module 122, such that the execution module 122 executes the task packet P1 to complete the execution task M1 corresponding to the task packet P1 (step S22).

In some embodiments, after the receive module 122 of the I3C controller 130 receives the task packet P1, the receive module 122 firstly reads the definition word W0 in the task packet P1, so that the receive module 122 can realize the first write number of the first data byte for the first write operation, the second write number of the second data byte for the second write operation, the read number that the byte required to read for the read operation, and the third write number of the third data byte for the third write operation according to the first setting byte B01, the second setting byte B02, the third setting byte B03, and the fourth setting byte B04 in the definition word W0.

Then, the execution module 122 can sequentially perform the following steps to complete the execution task M1: performing the first write operation according to the first write number of the first data byte in the at least one data byte B1-BN, performing the second write operation according to the second write number of the second data byte in the at least one data byte B1-BN, performing the read operation according to the read number, and performing the third write operation according to the third write number of the third data byte in the at least one data byte B1-BN.

In some embodiments, the execution module 122 can automatically send out a restart command (i.e., a restart condition, usually represented by “Sr”) after the execution module 122 completes the first write operation and before the execution module 122 performs the second write operation, or after the execution module 122 completes the read operation and before the execution module 122 performs the third write operation. Furthermore, in some embodiments, the execution module 122 can automatically send out a restart command or an end command (i.e., an end condition, usually represented by “P”) after the execution module 122 completes the third write operation.

In some embodiments, the execution task M1 may be a common command of common command code (CCC) set. Furthermore, the processing module 111 of the central processing unit 110 can set the first setting byte B01 of the definition word W0 as 0x02 (i.e., the first write number is 2), such that in response to that the execution module 122 of the I3C controller 120 executes the task packet P1, the I3C controller 120 takes the data bytes B1-B2 in the at least one data byte B1-BN as the two first data bytes, and the I3C controller 120 performs the first write operation according to these two first data bytes.

In some embodiments, a first byte in the first data bytes (i.e., the data byte B1) may include a broadcast address and a write bit, and a second byte in the first data bytes (i.e., the data byte B2) may include a common command code corresponding to the common command. In some embodiments, the write bit is a first value indicates that a write operation is to be performed; while the write bit is a second value indicates that a read operation is to be performed. In some embodiments, the broadcast address may be 7′h7E. The first value of the write bit may be 0 (i.e., 1′b0), and the second value of the write bit may be 1 (i.e., 1′b1). Furthermore, the common command code may be one in a range from 0x00 to 0xFE.

FIG. 6 illustrates a schematic view of a task packet P1 according to an embodiment of the instant disclosure. Please refer to FIG. 1 and FIG. 6. Take an example that each word is consisting of four bytes, the common command contained in the execution task M1 is an ENTDAA, and the number of slaves to be assigned with an address is 1. The processing module 111 of the central processing unit 110 can set the first setting byte B01 of the definition word W0 as 0x02 (i.e., the first write number is 2), set the second setting byte B02 of the definition word W0 as 0x01 (i.e., the second write number is 1), set the third setting byte B03 of the definition word W0 as 0x08 (i.e., the read number is 8), and set the fourth setting byte B04 of the definition word W0 as 0x01 (i.e., the third write number is 1). Furthermore, the processing module 111 of the central processing unit 110 generates one data word W1, that is, in some embodiments, the processing module 111 of the central processing unit 110 generates data bytes B1-B4. In this example, the processing module 111 can set the data byte B1 in the data word W1 as 0xfc (i.e., {7′h7E, 1′b0}), set the data byte B2 in the data word W1 as 0x07 (i.e., the common command code of the ENTDAA), set the data byte B3 in the data word W1 as 0xfd (i.e., {7′h7E, 1′b1}), and set the data byte B4 in the data word W1 as 0x47 (i.e., {7′h23, 1′b1}, wherein 7′h23 represents that an allocated address assigned to the slave is 0x23). Moreover, the processing module 111 of the central processing unit 110 concatenates and packages the definition word W0 and the data word W1 into a task packet P1. Then, the processing module 111 outputs the task packet P1 to the I3C controller 120 through the output module 112.

As a result, according to one or some embodiments of the instant disclosure, in response to that the execution module 122 of the I3C controller 120 executes the task packet P1, the execution module 122 writes the data bytes B1-B2 of the data word W1 into corresponding registers (e.g., the dedicated write registers) according to the first setting byte B01 of the definition word W0 (i.e., performs the first write operation), and the execution module 122 automatically sends out a restart command after the execution module 122 completes the first write operation. Next, the execution module 122 writes the data byte B3 of the data word W1 into corresponding registers (e.g., the dedicated write registers) according to the second setting byte B02 of the definition word W0 (i.e., performs the second write operation). Next, the execution module 122 reads eight bytes of data from corresponding registers (e.g., the dedicated read registers) according to the third setting byte B03 of the definition word W0 (i.e., performs the read operation). Then, the execution module 122 writes the data byte B4 of the data word W1 into corresponding registers (e.g., the dedicated write registers) according to the fourth setting byte B04 of the definition word W0 (i.e., performs the third write operation), and the execution module 122 automatically sends out an end command after the execution module 122 completes the third write operation. Accordingly, the I3C controller 120 thus completes the execution task M1 in which the ENTDAA assigns an allocated address to the slave.

Therefore, according to one or some embodiments of the instant disclosure, the central processing unit 110 just needs to generate a task packet P1 including two words (i.e., the definition word W0 and the data word W1) to the I3C controller 120, so that the I3C controller 120 can complete the execution task M1 in which the ENTDAA assigns an allocated address to the slave. Consequently, the processing flow of the I3C controller 120 can be simplified and the intervention of the central processing unit 110 can also be reduced, thereby reducing the loading of the central processing unit 110.

In some embodiments, the execution task M1 may be a write task. In these embodiments, the processing module 111 of the central processing unit 110 can define the third setting byte B03 of the definition word W0 as 0x00 (i.e., the read number is 0), such that in response to that the execution module 122 of the I3C controller 120 executes the task packet P1, the I3C controller 120 skips the read operation. Furthermore, the first byte in the first write number of first data bytes (i.e., the data byte B1) may include a write address (i.e., an allocated address assigned to a slave) and a write bit having a first value.

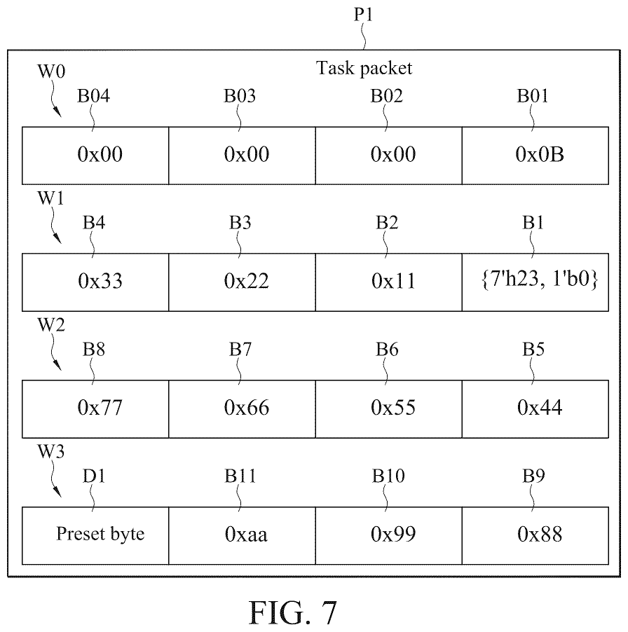

FIG. 7 illustrates a schematic view of a task packet P1 according to an embodiment of the instant disclosure. Please refer to FIG. 1 and FIG. 7. For example, each word is consisting of four bytes, and the execution task M1 is a write task to write 10 bytes of data (e.g., {0xaa998877665544332211}) to a slave having a write address (i.e., allocated address) 0x23. In this example, the processing module 111 of the central processing unit 110 can set the first setting byte B01 of the definition word W0 as 0x0B (i.e., the first write number is 11), and the processing module 111 can also set the second setting byte B02, the third setting byte B03, and the fourth setting byte B04 as 0x00 (i.e., the second write number, the read number, and the third write number are 0, respectively). Furthermore, the processing module 111 of the central processing unit 110 generates three data words W1-W3. After the processing module 111 concatenates and packages the definition word W0 and the data words W1-W3 into a task package P1, the processing module 111 transmits the task package P1 to the output module 112 to output the task package P1 to the I3C controller 120.

In this example, the data word W1 is consisting of data bytes B1-B4, the data word W2 is consisting of data bytes B5-B8, and the data word W3 is consisting of data bytes B9-B11 and one preset byte D1. In this example, the processing module 111 can: set the data byte B1 of the data word W1 as {7′h23,1′b0}, set the data byte B2 of the data word W1 as 0x11, set the data byte B3 of the data word W1 as 0x22, set the data byte B4 of the data word W1 as 0x33, set the data byte B5 of the data word W2 as 0x44, set the data byte B6 of the data word W2 as 0x55, set the data byte B7 of the data word W2 as 0x66, set the data byte B8 of the data word W2 as 0x77, set the data byte B9 of the data word W3 as 0x88, set the data byte B10 of the data word W3 as 0x99, and set the data byte B11 of the data word W3 as 0xaa.

As a result, according to one or some embodiments of the instant disclosure, in response to that the execution module 122 of the I3C controller 120 executes the task packet P1, the execution module 122 writes the data bytes B1-B11 in the data words W1-W3 into corresponding registers (e.g., the dedicated write registers) according to the first setting byte B01 of the definition word W0 (i.e., performs the first write operation), and the execution module 122 automatically sends out a restart command after the execution module 122 completes the first write operation. Next, the execution module 122 skips the second write operation, the read operation, and the third write operation according to the second setting byte B02, the third setting byte B03, and the fourth setting byte B04 of the definition word W0, and then automatically sends out an end command. Accordingly, the I3C controller 120 completes this write task (i.e., completes the execution task M1).

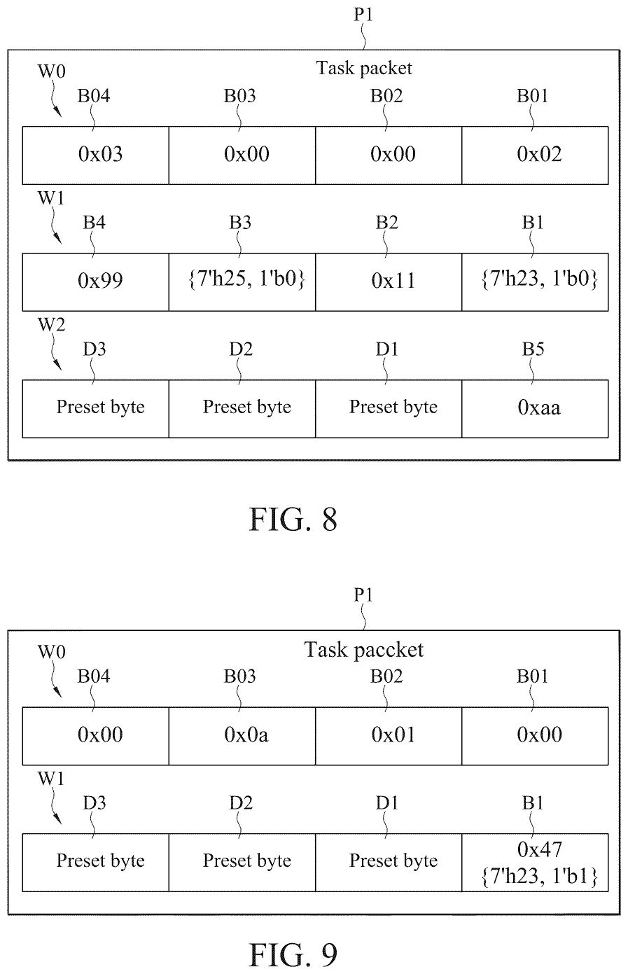

FIG. 8 illustrates a schematic view of a task packet P1 according to an embodiment of the instant disclosure. Please refer to FIG. 1 and FIG. 8. For another example, each word is consisting of four bytes, and the execution task M1 is a write task to write 1 byte of data (e.g., {0x11}) to a slave having a write address (i.e., allocated address) 0x23 and to write 2 bytes of data (e.g., {0xaa99}) to a slave having a write address (i.e., allocated address) 0x25. In this example, the processing module 111 of the central processing unit 110 can set the first setting byte B01 of the definition word W0 as 0x02 (i.e., the first write number is 2), set each of the second setting byte B02 and the third setting byte B03 of the definition word W0 as 0x00 (i.e., the second write number and the read number are 0, respectively), and set the fourth setting byte B04 of the definition word W0 as 0x03 (i.e., the third write number is 3). Furthermore, the processing module 111 of the central processing unit 110 generates two data words W1-W2. After the processing module 111 concatenates and packages the definition word W0 and the data words W1-W2 into a task package P1, the processing module 111 transmits the task package P1 to the output module 112 to output the task package P1 to the I3C controller 120.

In this example, the data word W1 is consisting of data bytes B1-B4, and the data word W2 is consisting of one data byte B5 and three preset bytes D1-D3. In this example, the processing module 111 can: set the data byte B1 of the data word W1 as {7′h23,1′b0}, set the data byte B2 of the data word W1 as 0x11, set the data byte B3 of the data word W1 as {7′h25,1′b0}, set the data byte B4 of the data word W1 as 0x99, and set the data byte B5 of the data word W2 as 0xaa.

As a result, according to one or some embodiments of the instant disclosure, in response to that the execution module 122 of the I3C controller 120 executes the task packet P1, the execution module 122 writes the data bytes B1-B2 in the data word W1 into corresponding registers (e.g., the dedicated write registers) according to the first setting byte B01 of the definition word W0 (i.e., performs the first write operation), and the execution module 122 automatically sends out a restart command after the execution module 122 completes the first write operation. Next, the execution module 122 skips the second write operation and the read operation according to the second setting byte B02 and the third setting byte B03 of the definition word W0. Then, the execution module 122 writes the data bytes B3-B4 in the data word W1 and the data byte B5 in the data word W2 into corresponding registers (e.g., the dedicated write registers) according to the fourth setting byte B04 of the definition word W0 (i.e., performs the third write operation), and the execution module 122 automatically sends out an end command after the execution module 122 completes the third write operation. Accordingly, the I3C controller 120 completes this write task (i.e., completes the execution task M1).

In some embodiments, an execution task M1 may be a read task. In these embodiments, the processing module 111 of the central processing unit 110 can respectively set the first setting byte B01 and the fourth setting byte B04 of the definition word W0 as 0x00 (i.e., the first write number and the third write number are 0, respectively), such that in response to the execution module 122 of the I3C controller 120 executes the task packet P1, the I3C controller 120 skips the first write operation and the third write operation. Furthermore, the second write number of the second data byte may include a write command. The write command includes a write address (i.e., an allocated address assigned to a slave) and a write bit having the second value.

FIG. 9 illustrates a schematic view of a task packet P1 according to an embodiment of the instant disclosure. Please refer to FIG. 1 and FIG. 9. For another example, each word is consisting of four bytes, and the execution task M1 is a read task to read 10 bytes of data from a slave having an address (i.e., allocated address) 0x23. In this example, the processing module 111 of the central processing unit 110 can set the first setting byte B01 of the definition word W0 as 0x00 (i.e., the first write number is 0), set the second setting byte B02 of the definition word W0 as 0x01 (i.e., the second write number is 1), set the third setting byte B03 of the definition word W0 as 0x0a (i.e., the read number is 10), and set the fourth setting byte B04 of the definition word W0 as 0x00 (i.e., the third write number is 0). Furthermore, the processing module 111 of the central processing unit 110 generates one data word W1. After the processing module 111 concatenates and packages the definition word W0 and the data word W1 into a task package P1, the processing module 111 transmits the task package P1 to the output module 112 to output the task package P1 to the I3C controller 120. In this example, the data word W1 is consisting of data byte Bland three preset bytes D1-D3. In this example, the processing module 111 can set the data byte B1 of the data word W1 as 0x47 (i.e., {7′h23,1′b1}, wherein 7′h23 is configured to represent that the write address is 0x23, and 1′b1 is configured to represent that the write bit has the second value).

As a result, according to one or some embodiments of the instant disclosure, in response to that the execution module 122 of the I3C controller 120 executes the task packet P1, the execution module 122 skips the first write operation according to the first setting byte B01 of the definition word W0, and then automatically sends out a restart command. Next, the execution module 122 writes the data byte B1 in the data word W1 into corresponding registers (e.g., the dedicated write registers) according to the second setting byte B02 of the definition word W0 (i.e., performs the second write operation). Next, the execution module 122 reads 10 bytes of data from the slave having the allocated address 0x23 according to the third setting byte B03 of the definition word W0 (i.e., performs the read operation). Then, the execution module 122 skips the third write operation according to the fourth setting byte B04 of the definition word W0 and automatically sends out an end command. Accordingly, the I3C controller 120 completes this read task (i.e., completes the execution task M1).

To sum up, according to the central processing unit 110, the I3C controller 120, and the processing method for the task packet P1 of one or some embodiments of the instant disclosure, according to an execution task M1, a task packet P1 can be generated or the task packet P1 of the execution task M1 can be executed, so that the central processing unit 110 sends the instructions and data for the I3C controller 120 to complete the execution task M1 to the I3C controller 120 in a single task packet P1 at once, such that the execution of the execution task M1 is completed after the I3C controller 120 completes the execution of the task packet P1. As a result, during the process of the I3C controller 120 executing the task packet P1 (i.e., before the completion of the execution task M1), the central processing unit 110 does not need to access the I3C controller 120 again, thereby greatly simplifying the processing flow of the I3C controller 120, and thus the waiting time and access times of the central processing unit 110 to the I3C controller 120 can be reduced (i.e., an intervention of the central processing unit 110 can be reduced) to reduce the loading of the central processing unit 110.

Although the instant disclosure has been described in considerable detail with reference to certain preferred embodiments thereof, the disclosure is not for limiting the scope of the application. Persons having ordinary skill in the art may make various modifications and changes without departing from the scope and spirit of the instant disclosure. Therefore, the scope of the appended claims should not be limited to the description of the preferred embodiments described above.

What is claimed is:

1. A central processing unit, comprising:
a processing module configured to generate a task packet according to an execution task, wherein the task packet comprises a definition word and at least one data byte, the at least one data byte sequentially follows the definition word, the definition word comprises a first setting byte, a second setting byte, a third setting byte, and a fourth setting byte that are sequentially concatenated one another, the first setting byte defines a first write number for a first write operation, the second setting byte defines a second write number for a second write operation, the third setting byte defines a read number for a read operation, the fourth setting byte defines a third write number for a third write operation, and the execution task comprises at least one selected from the group consisting of the first write operation, the second write operation, the read operation, and the third write operation; and
an output module configured to output the task packet to an I3C (improved inter integrated circuit) controller coupled to the central processing unit, such that the I3C controller executes the task packet to complete the execution task.

2. The central processing unit according to claim 1, wherein the first setting byte is configured to cause the I3C controller to perform the first write operation according to the first write number of first data byte in the at least one data byte, the second setting byte is configured to cause the I3C controller to perform the second write operation according to the second write number of second data byte in the at least one data byte, the third setting byte is configured to cause the I3C controller to perform the read operation according to the read number, and the fourth setting byte is configured to cause the I3C controller to perform the third write operation according to the third write number of third data byte in the at least one data byte.

3. The central processing unit according to claim 2, wherein in response to that the execution task is a common command, the first write number is 2, and wherein a first byte in the first write number of the first data byte comprises a broadcast address and a write bit, and a second byte in the first write number of the first data bytes comprises a common command code corresponding to the common command.

4. The central processing unit according to claim 3, wherein in response to that the common command is ENTDAA, the first write number of the first data byte sequentially comprise 0xfc and 0x07, the second write number of the second data byte comprises 0xfd, the read number is 8, and the third write number of the third data byte comprises an assigned address.

5. The central processing unit according to claim 1, wherein the I3C controller sends a restart command after the I3C controller completes the first write operation or the read operation.

6. The central processing unit according to claim 1, wherein the I3C controller sends a restart command or an end command after the I3C controller completes the third write operation.

7. The central processing unit according to claim 1, wherein in response to that the execution task is a write task, the read number is 0.

8. The central processing unit according to claim 7, wherein a first byte in the first write number of first data byte comprises a write address and comprises a write bit having a first value.

9. The central processing unit according to claim 1, wherein in response to that the execution task is a read operation, the first write number and the third write number are 0, the read number is greater than 0, the second write number of second data byte in the at least one data byte comprises a write command, and the write command comprises a write address and comprises a write bit having a second value.

10. An I3C (improved inter integrated circuit) controller, comprising:
a receive module configured to receive a task packet, wherein the task packet comprises a definition word and at least one data byte, and the at least one data byte sequentially follows the definition word, and wherein the definition word comprises a first setting byte, a second setting byte, a third setting byte, and a fourth setting byte that are sequentially concatenated one another, the first setting byte defines a first write number for a first write operation, the second setting byte defines a second write number for a second write operation, the third setting byte defines a read number for a read operation, and the fourth setting byte defines a third write number for a third write operation; and
an execution module configured to execute the task packet to complete an execution task, wherein the execution task comprises at least one selected from the group consisting of the first write operation, the second write operation, the read operation, and the third write operation.

11. The I3C controller according to claim 10, wherein in response to that the execution module executes the task packet, the execution module sequentially: performs the first write operation with the first write number of first data byte in the at least one data byte according to the first setting byte, performs the second write operation with the second write number of second data byte in the at least one data byte according to the second setting byte, performs the read operation according to the read number of the third setting byte, and performs the third write operation with the third write number of third data byte in the at least one data byte according to the fourth setting byte.

12. The I3C controller according to claim 11, wherein in response to that the execution task is a common command, the first write number is 2, and wherein a first byte in the first write number of the first data byte comprises a broadcast address and a write bit, and a second byte in the first write number of the first data bytes comprises a common command code corresponding to the common command.

13. The I3C controller according to claim 12, wherein in response to that the common command is ENTDAA, the first write number of the first data bytes sequentially comprise 0xfc and 0x07, the second write number of the second data byte comprises 0xfd, the read number is 8, and the third write number of the third data byte comprises an assigned address.

14. The I3C controller according to claim 10, wherein the execution module sends a restart command after the execution module completes the first write operation or the read operation.

15. The I3C controller according to claim 10, wherein the execution module sends a restart command or an end command after the execution module completes the third write operation.

16. The I3C controller according to claim 10, wherein in response to that the execution task is a write task, the read number is 0, and wherein in response to that the execution module executes the task packet, the execution module skips the read operation.

17. The I3C controller according to claim 16, wherein a first byte in the first write number of first data byte in the at least one data byte comprises a write address and comprises a write bit having a first value.

18. The I3C controller according to claim 10, wherein in response to that the execution task is a read operation, the first write number and the third write number are 0, the read number is greater than 0, the second write number of second data byte in the at least one data byte comprises a write command, and the write command comprises a write address and comprises a write bit having a second value.

19. A processing method for a task packet, comprising:
generating, using a central processing unit, a definition word according to an execution task, wherein the definition word comprises a first setting byte, a second setting byte, a third setting byte, and a fourth setting byte that are sequentially concatenated one another, the first setting byte defines a first write number for a first write operation, the second setting byte defines a second write number for a second write operation, the third setting byte defines a read number for a read operation, the fourth setting byte defines a third write number for a third write operation, and the execution task comprises at least one selected from the group consisting of the first write operation, the second write operation, the read operation, and the third write operation;
generating, using the central processing unit, at least one data byte according to the execution task;
concatenating, using the central processing unit, the at least one data byte after the definition word to generate a task packet; and
outputting, using the central processing unit, the task packet to an I3C (improved inter integrated circuit) controller, such that the I3C controller executes the task packet to complete the execution task.

20. The processing method for the task packet according to claim 19, further comprising:
receiving, using the I3C controller, the task packet; and
executing, using the I3C controller, the task packet to complete the execution task, wherein the I3C controller sequentially: performs the first write operation with the first write number of first data byte in the at least one data byte according to the first setting byte, performs the second write operation with the second write number of second data byte in the at least one data byte according to the second setting byte, performs the read operation according to the read number of the third setting byte, and performs the third write operation with the third write number of third data byte in the at least one data byte according to the fourth setting byte.
